(19) United States
(12) Patent Application Publication
(10) Pub. No.: US 2026/0104881 A1
(43) Pub. Date: Apr. 16, 2026

(54) SELF-PROVISIONING DC-SCM CARD

(71) Applicant: American Megatrends International, LLC, Duluth, GA (US)

(72) Inventors: Sey Subramanian, Suwanee, GA (US); Gevin Taylor, Lawrenceville, GA (US); Winston Thangapandian, Suwanee, GA (US); Muthukkumaran Ramalingam, Cumming, GA (US); Aaron Setser, Brookhaven, GA (US)

(21) Appl. No.: 18/916,013

(22) Filed: Oct. 15, 2024

(51) Int. Cl. G06F 8/65; G06F 8/71

(52) U.S. Cl. CPC G06F 8/65; G06F 8/71

(57) ABSTRACT

In an aspect of the disclosure, a method, a computer-readable medium, and an apparatus are provided. The apparatus may be a BMC. The BMC reads a hardware identifier from a host processor module (HPM) through its kickstarter firmware. The BMC then transmits this hardware identifier to a data center manager (DCM) using the kickstarter firmware. Subsequently, the BMC receives firmware images from the DCM. These firmware images correspond to the hardware identifier that was previously sent. The BMC then proceeds to update its own firmware and the basic input/output system (BIOS) based on the received firmware images.

### BACKGROUND

### Field

The present disclosure relates generally to computer systems, and more particularly, to techniques of self-provisioning firmware for modular hardware systems utilizing a Data Center Secure Control Module (DC-SCM) and a Data Center Manager (DCM) to dynamically update BIOS and BMC firmware based on hardware configurations.

### Background

The statements in this section merely provide background information related to the present disclosure and may not constitute prior art.

Considerable developments have been made in the arena of server management. An industry standard called Intelligent Platform Management Interface (IPMI), described in, e.g., “IPMI: Intelligent Platform Management Interface Specification, Second Generation,” v. 2.0, Feb. 12, 2004, defines a protocol, requirements and guidelines for implementing a management solution for server-class computer systems. The features provided by the IPMI standard include power management, system event logging, environmental health monitoring using various sensors, watchdog timers, field replaceable unit information, in-band and out of band access to the management controller, SNMP traps, etc.

A component that is normally included in a server-class computer to implement the IPMI standard is known as a Baseboard Management Controller (BMC). A BMC is a specialized microcontroller embedded on the motherboard of the computer, which manages the interface between the system management software and the platform hardware. The BMC generally provides the “intelligence” in the IPMI architecture. The BMC may be considered as an embedded-system device or a service processor. A BMC may require a firmware image to make them operational. “Firmware” is software that is stored in a read-only memory (ROM) (which may be reprogrammable), such as a ROM, programmable read-only memory (PROM), erasable programmable read-only memory (EPROM), electrically erasable programmable read-only memory (EEPROM), etc.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a BMC. The BMC reads a hardware identifier from a host processor module (HPM) through its kickstarter firmware. The BMC then transmits this hardware identifier to a data center manager (DCM) using the kickstarter firmware. Subsequently, the BMC receives firmware images from the DCM. These firmware images correspond to the hardware identifier that was previously sent. The BMC then proceeds to update its own firmware and the basic input/output system (BIOS) based on the received firmware images. This process allows the BMC to ensure that it has the correct firmware for the specific hardware configuration of the system it is managing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating a computer system including a baseboard management controller and a host computer.

FIG. 2 is a diagram illustrating a modular hardware system including a Data Center Security and Control Module and a Host Processor Module.

FIG. 3 is a diagram illustrating a self-provisioning system for a Data Center Secure Control Module in a modular hardware environment.

FIG. 4 is a block diagram illustrating a Data Center Manager including a Firmware Orchestration Service.

FIG. 5 is a flow chart of a method for self-provisioning firmware in a modular hardware system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computer systems will now be presented with reference to various apparatus and methods. These apparatus and methods will be described in the following detailed description and illustrated in the accompanying drawings by various blocks, components, circuits, processes, algorithms, etc. (collectively referred to as elements). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a processing system that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

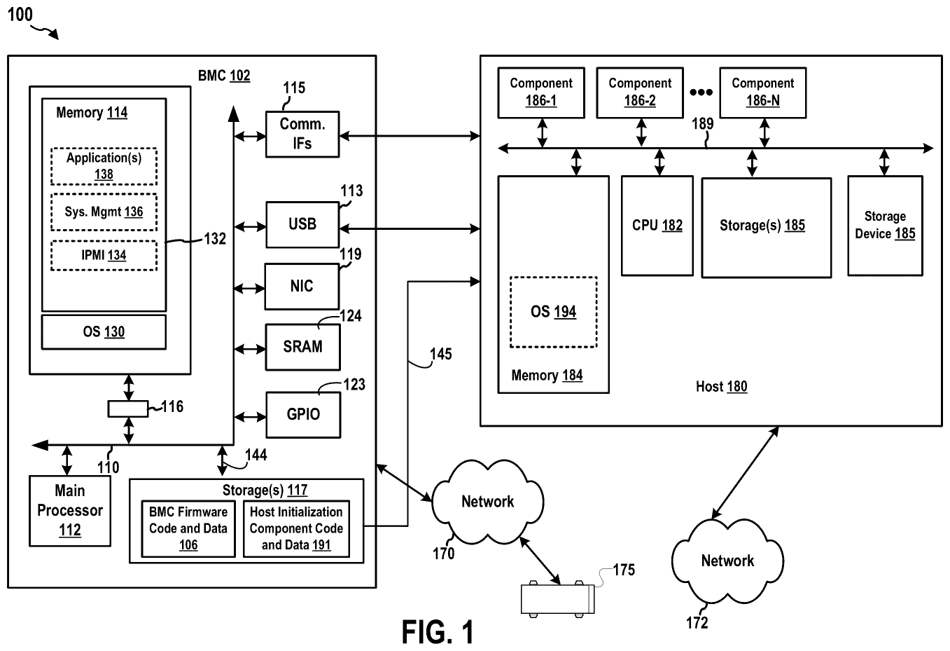

FIG. 1 is a diagram illustrating a computer system 100. In this example, the computer system includes, among other devices, a baseboard management controller (BMC) 102 and a host computer 180. The BMC 102 has, among other components, a main processor 112, a memory 114 (e.g., a dynamic random access memory (DRAM)), a memory driver 116, storage(s) 117, a network interface card 119, a USB interface 113 (i.e., Universal Serial Bus), other communication interfaces 115, a SRAM 124 (i.e., static RAM), and a GPIO interface 123 (i.e., general purpose input/output interface).

The communication interfaces 115 may include a keyboard controller style (KCS), a server management interface chip (SMIC), a block transfer (BT) interface, a system management bus system interface (SSIF), and/or other suitable communication interface(s). Further, as described infra, the BMC 102 supports IPMI and provides an IPMI interface between the BMC 102 and the host computer 180. The IPMI interface may be implemented over one or more of the USB interface 113, the network interface card 119, and the communication interfaces 115.

In certain configurations, one or more of the above components may be implemented as a system-on-a-chip (SoC). For examples, the main processor 112, the memory 114, the memory driver 116, the storage(s) 117, the network interface card 119, the USB interface 113, and/or the communication interfaces 115 may be on the same chip. In addition, the memory 114, the main processor 112, the memory driver 116, the storage(s) 117, the communication interfaces 115, and/or the network interface card 119 may be in communication with each other through a communication channel 110 such as a bus architecture.

The BMC 102 may store BMC firmware code and data 106 in the storage(s) 117. The storage(s) 117 may utilize one or more non-volatile, non-transitory storage media. During a boot-up, the main processor 112 loads the BMC firmware code and data 106 into the memory 114. In particular, the BMC firmware code and data 106 can provide in the memory 114 an BMC OS 130 (i.e., operating system) and service components 132. The service components 132 include, among other components, IPMI services 134, a system management component 136, and application(s) 138. Further, the service components 132 may be implemented as a service stack. As such, the BMC firmware code and data 106 can provide an embedded system to the BMC 102.

The BMC 102 may be in communication with the host computer 180 through the USB interface 113, the network interface card 119, the communication interfaces 115, and/or the IPMI interface, etc.

The host computer 180 includes a host CPU 182, a host memory 184, storage device(s) 185, and component devices 186-1 to 186-N. The component devices 186-1 to 186-N can be any suitable type of hardware components that are installed on the host computer 180, including additional CPUs, memories, and storage devices. As a further example, the component devices 186-1 to 186-N can also include Peripheral Component Interconnect Express (PCIe) devices, a redundant array of independent disks (RAID) controller, and/or a network controller.

Further, the storage(s) 117 may store host initialization component code and data 191 for the host computer 180. After the host computer 180 is powered on, the host CPU 182 loads the initialization component code and data 191 from the storage(s) 117 through the communication interfaces 115 and the communication channel 110. The host initialization component code and data 191 contains an initialization component. The host CPU 182 executes the initialization component. In one example, the initialization component is a basic input/output system (BIOS). In another example, the initialization component implements a Unified Extensible Firmware Interface (UEFI). UEFI is defined in, for example, “Unified Extensible Firmware Interface Specification Version 2.6, dated January, 2016,” which is expressly incorporated by reference herein in their entirety. As such, the initialization component may include one or more UEFI boot services.

The initialization component, among other things, performs hardware initialization during the booting process (power-on startup). For example, when the initialization component is a BIOS, the initialization component can perform a Power On System Test, or Power On Self Test, (POST). The POST is used to initialize the standard system components, such as system timers, system DMA (Direct Memory Access) controllers, system memory controllers, system I/O devices and video hardware (which are part of the component devices 186-1 to 186-N). As part of its initialization routine, the POST sets the default values for a table of interrupt vectors. These default values point to standard interrupt handlers in the memory 114 or a ROM. The POST also performs a reliability test to check that the system hardware, such as the memory and system timers, is functioning correctly. After system initialization and diagnostics, the POST surveys the system for firmware located on non-volatile memory on optional hardware cards (adapters) in the system. This is performed by scanning a specific address space for memory having a given signature. If the signature is found, the initialization component then initializes the device on which it is located. When the initialization component includes UEFI boot services, the initialization component may also perform procedures similar to POST.

After the hardware initialization is performed, the initialization component can read a bootstrap loader from a predetermined location from a boot device of the storage device(s) 185, usually a hard disk of the storage device(s) 185, into the host memory 184, and passes control to the bootstrap loader. The bootstrap loader then loads an OS 194 into the host memory 184. If the OS 194 is properly loaded into memory, the bootstrap loader passes control to it. Subsequently, the OS 194 initializes and operates. Further, on certain disk-less, or media-less, workstations, the adapter firmware located on a network interface card re-routes the pointers used to bootstrap the operating system to download the operating system from an attached network.

The service components 132 of the BMC 102 may manage the host computer 180 and is responsible for managing and monitoring the server vitals such as temperature and voltage levels. The service stack can also facilitate administrators to remotely access and manage the host computer 180. In particular, the BMC 102, via the IPMI services 134, may manage the host computer 180 in accordance with IPMI. The service components 132 may receive and send IPMI messages to the host computer 180 through the IPMI interface.

Further, the host computer 180 may be connected to a data network 172. In one example, the host computer 180 may be a computer system in a data center. Through the data network 172, the host computer 180 may exchange data with other computer systems in the data center or exchange data with machines on the Internet.

The BMC 102 may be in communication with a communication network 170 (e.g., a local area network (LAN)). In this example, the BMC 102 may be in communication with the communication network 170 through the network interface card 119. Further, the communication network 170 may be isolated from the data network 172 and may be out-of-band to the data network 172 and out-of-band to the host computer 180. In particular, communications of the BMC 102 through the communication network 170 do not pass through the OS 194 of the host computer 180. In certain configurations, the communication network 170 may not be connected to the Internet. In certain configurations, the communication network 170 may be in communication with the data network 172 and/or the Internet. In addition, through the communication network 170, a remote device 175 may communicate with the BMC 102. For example, the remote device 175 may send IPMI messages to the BMC 102 over the communication network 170. Further, the storage(s) 117 is in communication with the communication channel 110 through a communication link 144.

Further, the storage(s) 117 may include one or more SPI (Serial Peripheral Interface) devices. SPI is a synchronous serial communication protocol used for short-distance communication, primarily in embedded systems. SPI devices are widely used for connecting microcontrollers to peripherals such as sensors, SD cards, and flash memory.

The SPI device(s) within the storage(s) 117 may be implemented as electrically erasable programmable read-only memory (EEPROM) or NOR flash memory. They are non-volatile storage components that retain data even when the system power is turned off. The electrically erasable aspect allows for the contents of the memory to be rewritten or updated as needed.

The SPI device(s) can be used to store the Host Initialization Component Code and Data 191, which includes the system firmware necessary for booting the host computer 180. This firmware may comprise the Basic Input/Output System (BIOS) or Unified Extensible Firmware Interface (UEFI) firmware images. During the boot process, after the host computer 180 is powered on, the host CPU 182 accesses the SPI device(s) to load the initialization component code and data 191 into the host memory 184.

The host CPU 182 can access the SPI device(s) directly through dedicated SPI buses 145 connected between the host CPU 182 and the storage(s) 117. Alternatively, the access can occur via the communication interfaces 115 and the communication channel 110 if the system architecture routes SPI communication through intermediary components such as the BMC 102. In this case, the communication link 144 may include SPI buses.

The server market is currently witnessing a significant transformation due to most Original Equipment Manufacturers (OEMs) and Cloud Service Providers (CSPs) moving towards a modular hardware architecture in their server platforms. Open Compute Project (OCP) details the modularization criteria through its server hardware specifications. The idea behind this approach is to create a hardware ecosystem that is flexible, scalable, and easily upgradable, aligning with the rapid pace of technology advancements in server components.

The Data Center Ready-Modular Hardware System (DC-MHS) specification outlines the essential components of a modular platform. Key to this architecture is the facility it provides for CSPs and OEMs to upgrade existing systems without the need to invest in entirely new server platforms. The components within the servers, such as processors, storage devices, and management controllers, are designed to be replaceable or upgradable as individual units. This approach significantly reduces the Total Cost of Ownership (TCO) for the organizations, as components can be updated or replaced as needed, without a full system overhaul.

One of the primary benefits of adopting the DC-MHS guidelines is the agility it lends to system upgrades. Instead of the lengthy process traditionally involved in replacing or upgrading whole servers, modular components can be slotted in with minimal disruption, greatly accelerating the upgrade lifecycle and ensuring that server platforms can keep pace with evolving workloads and technological advancements.

A DC-MHS includes a Data Center Security and Control Module (DC-SCM). It incorporates essential subsystems such as the Baseboard Management Controller (BMC) stack and the Hardware Root of Trust (ROT). Further, the BIOS and BMC firmware SPI devices are moved from the Host Processor Module (HPM) to the DC-SCM. This modular approach centralizes the storage of critical firmware within the DC-SCM, which includes the BMC 102 and its associated storage(s) 117.

The DC-SCM is a compact module designed as a daughter card to be integrated onto a server motherboard. The DC-SCM encapsulates several critical management functionalities that are central to the operation and integrity of the server system. The DC-SCM's infrastructure allows it to be easily swapped out or upgraded without the necessitation of replacing the entire server.

The DC-SCM includes a BMC stack. The BMC stack is responsible for the monitorization of the server's hardware state, facilitating remote management capabilities such as power control, system restoration, and logging. The BMC supports the server's lifecycle by providing diagnostic tools, the ability to update firmware, and manage hardware settings even when the server OS is not running. The modularity of BMC within the DC-SCM means that, as server management needs evolve or as new BMC technology gets introduced, the BMC functionality can be updated or replaced independent of other hardware components.

The DC-SCM includes a Hardware Root of Trust (ROT). The ROT is essentially a trusted source of verification for software and firmware loads on the server, establishing a baseline of trust for all operations. It ensures that only signed, verified code is executed on startup to prevent unauthorized firmware from compromising server integrity.

The ROT mechanism functions as the root for all trust chains on the server, and integrating it within the DC-SCM enables a secure boot process. The ROT in the DC-SCM interacts with both the BMC SPI device and BIOS SPI devices to verify and authenticate the firmware before execution.

When the system powers on, the ROT initiates the secure boot process. It first accesses the BMC SPI device, which contains the BMC firmware. The ROT verifies the digital signature of the BMC firmware using cryptographic algorithms and keys stored within its secure environment. This verification ensures that the BMC firmware has not been tampered with and comes from a trusted source.

If the BMC firmware verification is successful, the ROT allows the BMC to boot. The BMC then takes control of the system management functions. As part of its initialization process, the BMC may perform additional security checks and prepare the system for the BIOS boot.

Next, the ROT interacts with the BIOS SPI devices. These devices store the BIOS firmware. The ROT again performs a signature verification on the BIOS firmware.

If the BIOS firmware passes the verification process, the ROT allows it to execute. The BIOS then proceeds with its normal boot sequence, initializing hardware and eventually loading the operating system.

The DC-MHS further includes an HPM. The HPM functions as the ‘brain’ of the system, hosting processors such as CPUs (Central Processing Units), GPUs (Graphics Processing Units), IPUs (Infrastructure Processing Units), DPUs (Data Processing Units), and accompanying DIMMs (Dual Inline Memory Modules) to provide computing and processing capabilities necessary for running applications and managing workloads.

With the modular approach of DC-MHS, the HPM, including its various processor types and memory, becomes a replaceable unit within the server architecture. Such modularity permits on-the-fly upgrades of the HPM to adapt to new technologies, workloads, or performance goals without the need for comprehensive system replacement. From swapping an outdated CPU to a more powerful one or adding high-capacity DIMMs, the HPM acts as an interchangeable module, facilitating seamless transitions and continuous performance optimization.

The DC-MHS also includes Modular I/O (DC-MIO). The DC-MIO deals with the varied input/output requirements of modern data centers, encapsulating subsystems for storage, network interface cards (NICs), accelerators, and a range of interconnect technologies. These modular components are utilized for a server's connectivity and throughput capabilities to specific workload demands.

The DC-MHS also utilizes SMART Network Interface Cards (NICs) and Data Plane technologies. SMART-NICs are advanced network cards with built-in processors—often based on Field-Programmable Gate Array (FPGA) technology or specific multicore CPUs—that can offload processing tasks from the server's central processing units (CPUs). These network interface cards enable sophisticated processing at the network edge, closer to where data is entering or leaving the server. This form of processing enables efficient data plane operations—those tasks concerned with the forwarding of data packets through the network.

The modular architecture of the DC-MHS improves server upgradeability and system management.

The DC-MHS utilizes modular hardware, enabling easy replacement of components and facilitating easy upgrades. Individual components of the DC-MHS, such as the Host Processor Module (HPM), the DC-SCM, and the Modular I/O, can be interchanged without the requirement of overhauling the entire server infrastructure.

Changes in the HPM can result in the creation of entirely new systems. An HPM upgrade, such as the replacement of a CPU with a more advanced variant, transforms the system's capabilities, aligning it with current performance requisites or specific computational needs.

The modular architecture enables a pay-as-you-go model. This model allows for incremental investments, where CSPs and OEMs can strategically upgrade hardware components based on evolving performance requirements or budget considerations, as opposed to incurring the cost of complete server replacements.

Changes to platform devices necessitate dynamic firmware capabilities, to ensure that upgrades or alterations in hardware are adequately supported by the system's software. An adaptable firmware framework can respond to changes in the HPM or other components, thus maintaining the integrity and functionality of the server's operations. The adaptable firmware framework serves this purpose by dynamically constructing firmware images tailored to the new configuration.

With the advent of a modular design, device and sensor configurations are no longer static but become dynamic entities within the server ecosystem. As components are added, removed, or upgraded, sensor configurations adapt accordingly, ensuring the ongoing accurate monitoring and management of server health and performance parameters.

Further, the DC-SCM enables changes to be made in the management module. Accordingly, the BMC firmware are readily adaptable to support fresh deployments or upgrades.

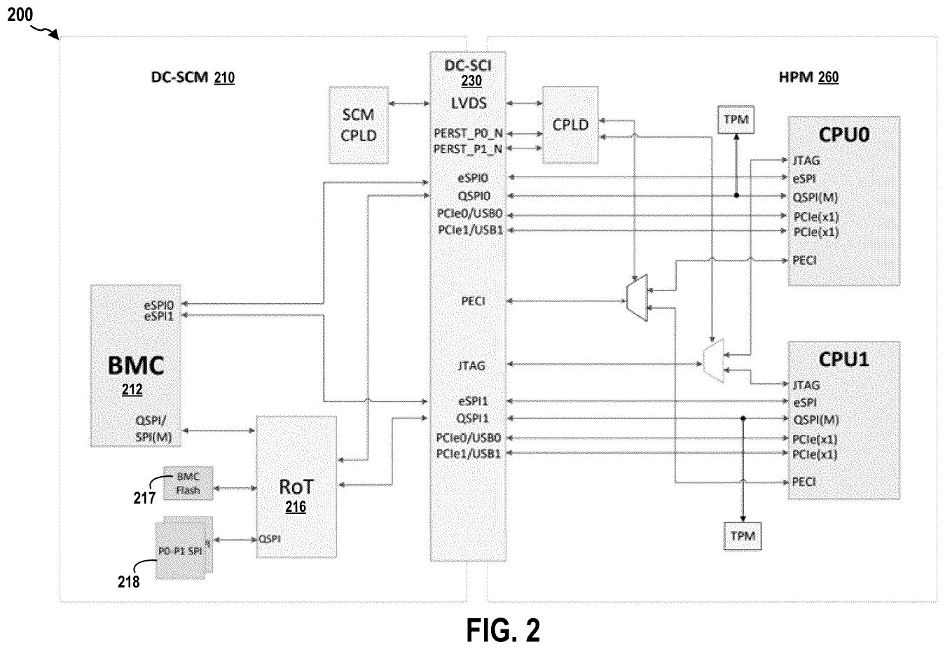

FIG. 2 is a diagram illustrating a modular hardware system 200. The modular hardware system 200 includes a DC-SCM 210, a HPM 260. The DC-SCM 210 includes a BMC 212 and HROT 216, and a Data Center System Connection Interface (DC-SCI) 230. The HROT 216 controls a BMC SPI 217 and BIOS SPIs 218. The SPIs 218 are used to store BIOS images.

The Host Processor Module (HPM) 260 includes a CPU0 and a CPU1. The DC-SCM 210 and the HPM 260 are connected via the DC-SCI 230. The DC-SCI 230 serves as the foundational communication backbone connecting the Data Center Security and Control Module (DC-SCM) 210 with the Host Processor Module (HPM) 260. It is equipped with a variety of interfaces and protocols designed to ensure a seamless and efficient data flow between the various server modules.

In the modular hardware system 200, the BMC 212 is part of the DC-SCM 210 and adheres to the specifications of the DC-SCM 210. As a replaceable unit within the DC-SCM 210, the BMC 212 may be transitioned between different BMC System-on-Chip (SOC) components provided by the OEMs and CSPs. Deployable firmware images may be supplied for these BMC modules. That is, the firmware is as interchangeable as the hardware components it manages. For example, the OpenBMC firmware is often used.

The HPM may change in a DC-MHS system. In the example of FIG. 2, the HPM 260 functions as the computing module or “brain” of the modular hardware system 200, hosting processors such as CPUs and GPUs along with memory. If the HPM 260 is upgraded or swapped out, it essentially changes the platform, as a new compute module is introduced. For example, the CPU0 and CPU1 in the existing HPM 260 could be replaced with a newer generation processor. The DC-SCI 230 provides standardized connectivity between the HPM and other modules such as the DC-SCM 210, abstracting low-level interface details. However, the BMC 212 in the DC-SCM 210 still needs awareness of the physical interfaces provided by a new HPM for proper management and monitoring. The BMC 212, residing in the DC-SCM 210, recognizes these changes and interacts appropriately with the new physical interfaces provided by the altered HPM.

The BMC 212 encapsulated in the DC-SCM 210 may also change. As a replaceable daughter card unit, an outdated BMC 212 SOC component could be upgraded to a newer generation BMC SOC with different firmware requirements. Customers utilizing AMI's BMC firmware stack require the flexibility to Tailored BMC firmware images may be built and deployed for any SOC and platform combination that may arise from BMC swaps. That is, the necessary BMC firmware may be generated on-the-fly to accommodate both the SOC and platform configurations. The BMC image should also inherit necessary configurations from the previous BMC while seamlessly supporting the new module.

Device configurations in the modular hardware system 200 are expected to change over time due to hardware lifecycle management involving addition, removal, or upgrades of devices. The BMC firmware has capabilities to dynamically handle such changes in devices and sensors, discovering new devices added and managing them appropriately. The BMC 212 can handle device changes occurring.

The DC-SCI 230, as the primary conduit for communication and interaction among the modular components of the DC-MHS, adheres to a set standard specification. This standardization ensures that, despite the mutable nature of the aforementioned elements (HPM, BMC, and device configurations), the foundational interconnectivity remains consistent and reliable. The DC-SCI 230's role is to provide a stable and secure platform upon which these interchangeable components can operate cohesively.

In the modular hardware system 200 shown in FIG. 2, the DC-SCM 210 and HPM 260 are separate replaceable modules connected via the DC-SCI 230 interface. As discussed, the HPM 260 as the compute module can be swapped out or upgraded, essentially changing the platform. Similarly, the BMC 212 within the DC-SCM 210 is a replaceable daughter card unit that can also be changed to a newer generation BMC SOC.

To handle such mutable components and platforms, the BMC firmware also has portability. The firmware is configurable to support any alterations occurring in modules of the modular hardware system 200 such as the HPM 260 or BMC 212. For example, if the HPM 260 is swapped from one processor to another, the firmware of the BMC 212 can dynamically handle the new physical interfaces and devices presented by the changed HPM module.

As described supra, the Data Center Secure Control Module (DC-SCM) provides a modular solution to enhance server management, security, and control features. The BIOS and BMC firmware flash devices are moved from the traditional processor motherboard, known as the Host Processor Module (HPM), to the DC-SCM, which is a separate, pluggable board. While this modular approach offers significant advantages in terms of flexibility and upgradability, it also presents certain challenges that need to be addressed.

The DC-SCM 210 may encounter firmware compatibility issues that may arise due to the close relationship between the firmware and the specific configuration of the HPM. This tight coupling between firmware and hardware components such as processors, devices, sensors, and other elements of the HPM creates potential compatibility issues when changing DC-SCM cards coupled to particular HPMs.

One of the primary concerns is the execution of pre-boot binaries, which are specific to the processor architecture and vendor. These binaries must be executed before the BIOS firmware can initiate. If an incorrect pre-boot binary is used, it can result in a system hang during the early boot stages. This scenario is particularly problematic as it occurs before the BIOS can execute and report any errors, making diagnosis in the field challenging.

The issue is further compounded when considering the variety of processors and configurations in a data center environment. For instance, manually installing DC-SCM cards with vendor-specific BIOS coupled to HPMs with different vendor's processor are prong to mistakes. Despite the DC-SCM being designed as a modular and standardized component, the incorrect pairing of a DC-SCM card with an incompatible HPM can lead to significant confusion and potentially trigger the need for technical support.

On the BMC side, similar compatibility issues arise. While the BMC controller is housed on the DC-SCM card, each HPM may have its unique set of sensors and controllers. The pre-programmed BMC firmware on the DC-SCM card may not have support for the various HPMs it might encounter. This lack of universal compatibility is not addressed in the current DC-SCM specification, as it primarily focuses on the electrical aspects of the interface.

In one exemplary scenario, multiple variants of processors from different vendors such as Intel, AMD, and ARM are used on different HPMs. The permutations of possible combinations between DC-SCM cards and HPMs increase dramatically. In a hypothetical setup with 10 different systems and 10 different SCM cards with firmware, the probability of a randomly selected DC-SCM card working correctly with a given server is 10%. This shows in production environments and data centers, where incorrect installations may happen and may lead to widespread system failures and increased downtime.

These firmware incompatibility issues pose a significant challenge, especially in large-scale deployments such as data centers. The potential for mismatched DC-SCM cards and HPMs increases with the scale of deployment, requiring substantial manual effort to ensure proper pairing and functionality. This situation is far from ideal in environments where efficiency and reliability are paramount.

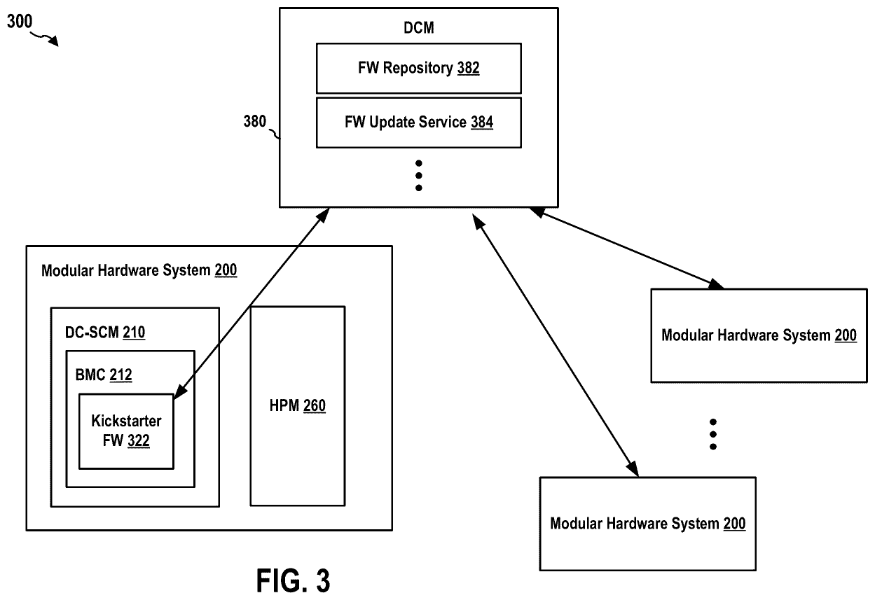

FIG. 3 is a diagram 300 illustrating a self-provisioning system for a Data Center Secure Control Module (DC-SCM) in a modular hardware environment. The DCM 380 includes, among other components, a firmware repository 382 and a firmware update service 384. The DCM 380 serves as a central orchestration system for managing firmware in a modular hardware environment, particularly addressing the challenges posed by the Data Center Secure Control Module (DC-SCM) architecture.

The DCM 380 manages a repository of BIOS & BMC firmware images. This repository is utilized to store multiple firmware images that align with the specific hardware configurations of the modular systems. In certain configurations, the orchestration process executed by the DCM 380 involves selecting and assembling these components to create tailored firmware images.

The firmware of a DC-SCM card, such as the DC-SCM 210, includes a BIOS image and a BMC firmware image. The BIOS image is typically specific to the host processor module (HPM), such as the HPM 260, and the BMC firmware image is specific to the BMC chip, such as the BMC 212. For example, if an Intel CPU is used in the HPM 260, the BIOS image must be compatible with the Intel CPU and if an AMD CPU is used in the HPM 260, the BIOS image must be compatible with the AMD CPU. Similarly, if an ASPEED BMC chip is used, such as the BMC 212, the BMC firmware must be compatible with the ASPEED BMC chip, and if a Nuvoton BMC chip is used, the BMC firmware must be compatible with the Nuvoton BMC chip.

To address the firmware compatibility issues arising from the modular DC-SCM architecture, the DCM 380 implements firmware repository 382 that includes various BIOS images and BMC firmware images, each for different hardware configurations.

In this system, a DC-SCM 210 is initially plugged into a modular hardware system 200 having an HPM 260. The DC-SCM 210 includes a BMC 212 provided with kickstarter firmware 322. The BMC 212 has a BMC SPI 217 and BIOS SPIs 218.

The kickstarter firmware 322 is designed with specific capabilities to facilitate the self-provisioning process. It has network capabilities via the DC-SCM RGMII interface, which allows it to communicate with the DCM 380. Additionally, it has flash write capability to both the BMC SPI 217 and the BIOS SPIs 218, enabling it to update the firmware as needed. The kickstarter firmware 322 also has read capability into I2C/I3C buses via the DC-SCI 230, which is crucial for identifying the specific hardware configuration of the HPM 260.

All known and supported HPMs house a unique board identifying I2C/I3C slave device (I2C ID Device) on a specific slave address chosen by the DC-SCM/HPM vendor. This I2C ID Device serves as a hardware identifier for the specific configuration of the HPM 260. The board identification device is configured to provide a unique identification for the HPM. For example, if the HPM 260 includes an Intel CPU, the board identification device can be configured to provide the identification “10”. As another example, if the HPM 260 includes an AMD CPU, the board identification device can be configured to provide the identification “20”.

Upon power-on, the kickstarter firmware 322 initiates a process to identify the specific hardware configuration. It reads all I2C/I3C buses, probing for the I2C ID Device at the selected slave address. When the I2C ID Device is found, the BMC 212 reads the ID from the device. This ID serves as a unique identifier for the specific hardware configuration of the HPM 260.

The BMC 212 then uses this ID to communicate with the DCM 380 via the RGMII interface. It requests the correct pair of BIOS and BMC firmware for the specific HPM configuration from the DCM 380. The DCM 380, using its firmware repository 382 and firmware update service 384, identifies the appropriate firmware based on the ID provided by the BMC 212.

Once the correct firmware is identified, the DCM 380 sends it back to the BMC 212. The kickstarter firmware 322 then uses its flash write capability to program the received firmware onto the BIOS and BMC flash devices. After the firmware update is complete, the BMC 212 triggers a system reset.

This process allows the system to be provisioned with the correct set of firmware for its specific hardware configuration. When the system restarts, it boots with the appropriate firmware without any manual intervention or additional setup. This self-provisioning mechanism significantly simplifies large-scale deployments of DC-SCM based systems in data centers.

The self-provisioning system addresses several challenges in the deployment of modular hardware systems. It eliminates the need for manual matching of DC-SCM cards with specific HPMs, reducing the potential for human error. It also allows for greater flexibility in hardware upgrades and replacements, as any DC-SCM card can potentially work with any HPM, provided the correct firmware is available in the DCM 380.

This system is particularly beneficial in large data center environments where there may be thousands of servers with various configurations. The self-provisioning capability allows for efficient management of these diverse systems, reducing downtime and simplifying the process of hardware upgrades or replacements.

The DCM 380 maintains a comprehensive repository of firmware for various hardware configurations. It can handle a large number of different hardware IDs, potentially thousands, and map them to the appropriate firmware versions. This allows the DCM 380 to provide the correct firmware even in environments with a wide variety of hardware configurations.

The kickstarter firmware 322 is designed to be minimal yet functional. It includes only the essential components needed for network access, hardware identification, and firmware updating. In scenarios where there might be multiple variants of DC-SCM cards with different BMC chips, such as those from ASPEED or Nuvoton, the kickstarter firmware 322 flashed onto these cards during manufacturing is specific to the BMC chip used. When communicating with the DCM 380, the kickstarter firmware also sends information about the BMC chip type, allowing the DCM 380 to provide the appropriate firmware version.

The self-provisioning system also accommodates changes in the HPM 260. If a DC-SCM card is moved from one system to another with a different HPM configuration (for example, from an Intel-based system to an AMD-based system), the kickstarter firmware 322 will detect this change through the I2C ID Device. It will then request and apply the appropriate firmware from the DCM 380, allowing the DC-SCM card to function correctly with the new HPM.

This flexibility extends to various aspects of the server configuration, including different CPU types, different generations of the same CPU type, and different board designs using the same CPU. The system can handle these variations by using unique IDs for each specific configuration and maintaining the corresponding firmware in the DCM 380.

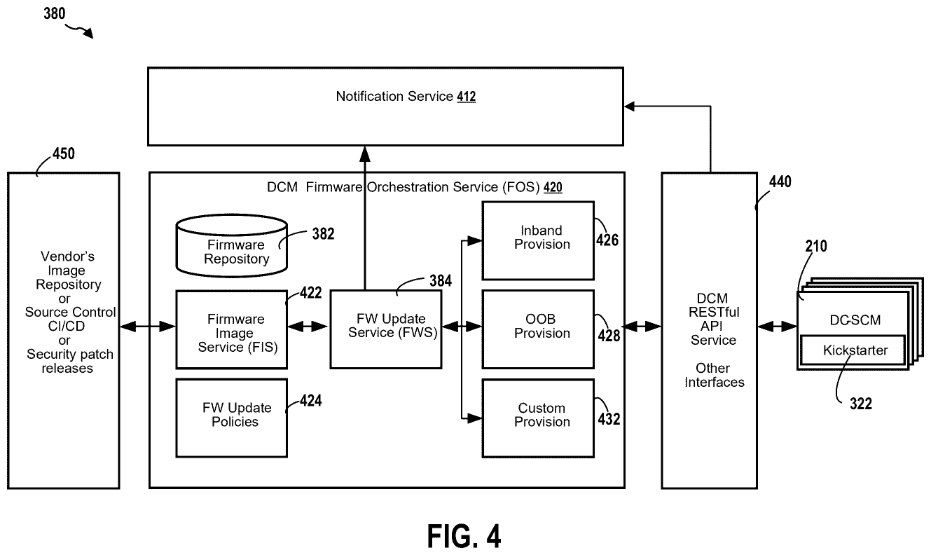

FIG. 4 is a block diagram illustrating a Data Center Manager (DCM) 380. The DCM 380 includes a Firmware Orchestration Service (FOS) 420, which is a software service that provides a centralized platform for managing and orchestrating firmware updates across servers in a data center environment.

The FOS 420 receives notifications from a notification service 412 about new firmware releases or updates available from vendors. These notifications can include information about new BIOS images, BMC firmware images, or other firmware components relevant to the servers being managed. The notification service 412 may also alert administrators about firmware update activities, addressing the need for visibility in large-scale deployments.

The FOS 420 also communicates with a DCM RESTful API Service 440, which provides an interface for external systems or applications to interact with the FOS 420 and request firmware updates or retrieve information about available firmware versions.

Within the DCM Firmware Orchestration Service (FOS) 420, a Firmware Image Service (FIS) 422 handles firmware images. It subscribes to vendor image repositories, such as the image repository 450, to receive notifications about new firmware image releases. When a new image becomes available, the FIS 422 downloads it and updates the firmware repository 382, which serves as a central storage location for all firmware components managed by the FOS 420. The firmware repository 382 can store a variety of firmware images, including BIOS images specific to different HPMs like the HPM 260, BMC firmware images specific to different BMC chips like the BMC 212, and other firmware components needed for different hardware configurations.

The FOS 420 also includes a firmware update service (FWS) 384, which is responsible for orchestrating the actual firmware update process on the servers. It works in conjunction with the firmware update policies 424, which define the rules and guidelines for how firmware updates should be applied. These policies can specify factors such as the timing of updates, the order in which updates are applied, and any pre- or post-update actions that need to be taken.

The FWS 384 supports various firmware provisioning methods, including in-band provisioning through inband provision 426, out-of-band provisioning through OOB provision 428, and custom provisioning methods through custom provision 432. In-band provisioning typically involves updating firmware through the server's operating system, while out-of-band provisioning utilizes dedicated management interfaces, such as the IPMI interface of the BMC 212, to update firmware without affecting the server's operating system. Custom provisioning methods can be used to handle specific firmware update scenarios or requirements that may not be covered by standard in-band or out-of-band methods.

The FOS 420 manages firmware updates in the modular hardware system 200. It can handle the dynamic nature of these systems, where components like the HPM 260 or the BMC 212 may be swapped or upgraded, leading to changes in firmware requirements. By utilizing the kickstarter firmware 322 on the DC-SCM 210, the FOS 420 can automatically identify the hardware configuration of each server and provision the correct firmware images accordingly. This self-provisioning capability simplifies firmware management, reduces the risk of errors, and helps to maintain the stability and security of the data center environment. As such, the FOS 420 provides a centralized platform for managing and orchestrating firmware updates.

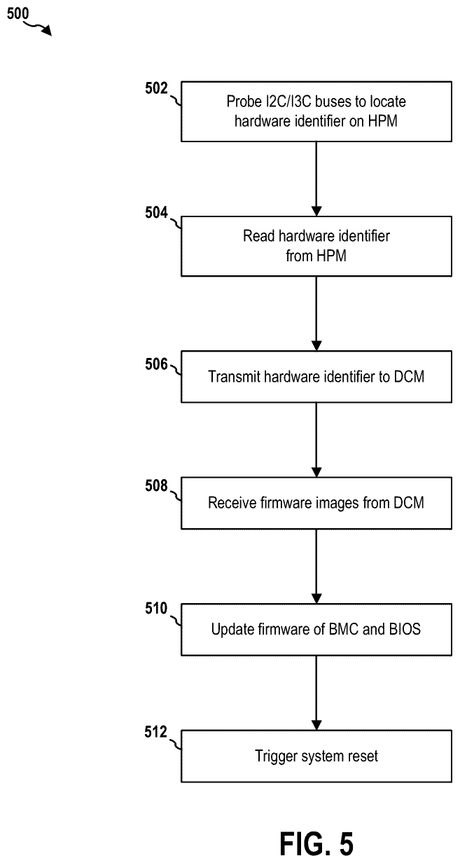

FIG. 5 is a flow chart 500 of a method (process) for self-provisioning firmware in a modular hardware system. The method may be performed by a baseboard management controller (BMC) (e.g., the BMC 212). In operation 502, the BMC probes, by a kickstarter firmware, multiple I2C/I3C buses to locate a hardware identifier on a host processor module (HPM). In operation 504, the BMC reads, by the kickstarter firmware, the hardware identifier from the HPM. In certain configurations, the hardware identifier is read from an I2C/I3C slave device on the HPM. In operation 506, the BMC transmits, by the kickstarter firmware, the hardware identifier to a data center manager (DCM). In certain configurations, to transmit the hardware identifier to the DCM, the BMC uses a Reduced Gigabit Media Independent Interface (RGMII). In certain configurations, the kickstarter firmware includes network capabilities, flash write capabilities for both BMC and BIOS flash devices, and read capabilities for I2C/I3C buses.

In operation 508, the BMC receives, from the DCM, firmware images corresponding to the hardware identifier. In operation 510, the BMC updates firmware of the BMC and BIOS based on the received firmware images. In certain configurations, the firmware images include a BMC firmware image specific to a BMC chip type and a BIOS image specific to a processor type of the HPM. To update the firmware, the BMC writes the received firmware images to a BIOS flash device and a BMC flash device within the BMC. In operation 512, the BMC triggers a system reset after updating the firmware of the BMC and the BIOS.

In certain configurations, the DCM maintains a firmware repository containing multiple versions of BIOS and BMC firmware images, each associated with specific hardware identifiers. The DCM updates the firmware repository with new firmware images upon receiving notifications from vendor image repositories.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of operation of a baseboard management controller (BMC), comprising:
reading, by a kickstarter firmware of the BMC, a hardware identifier from a host processor module (HPM);
transmitting, by the kickstarter firmware, the hardware identifier to a data center manager (DCM);
receiving, from the DCM, firmware images corresponding to the hardware identifier; and
updating firmware of the BMC and a basic input/output system (BIOS) based on the received firmware images.

2. The method of claim 1, wherein the hardware identifier is received from an I2C/I3C slave device on the HPM.

3. The method of claim 1, wherein transmitting the hardware identifier to the DCM is performed using a Reduced Gigabit Media Independent Interface (RGMII).

4. The method of claim 1, further comprising:
triggering a system reset after updating the firmware of the BMC and the BIOS.

5. The method of claim 1, wherein the kickstarter firmware includes network capabilities, flash write capabilities for both BMC and BIOS flash devices, and read capabilities for I2C/I3C buses.

6. The method of claim 1, wherein the firmware images include a BMC firmware image specific to a BMC chip type and a BIOS image specific to a processor type of the HPM.

7. The method of claim 1, wherein updating the firmware comprises:
writing the received firmware images to a BIOS flash device and a BMC flash device within the BMC.

8. The method of claim 1, further comprising:
probing, by the kickstarter firmware, multiple I2C/I3C buses to locate the hardware identifier on the HPM.

9. The method of claim 1, wherein the DCM maintains a firmware repository containing multiple versions of BIOS and BMC firmware images, each associated with specific hardware identifiers.

10. The method of claim 9, wherein the DCM updates the firmware repository with new firmware images upon receiving notifications from vendor image repositories.

11. A baseboard management controller (BMC), comprising:
a memory; and
at least one processor coupled to the memory and configured to:
read, via a kickstarter firmware of the BMC, a hardware identifier from a host processor module (HPM);
transmit, via the kickstarter firmware, the hardware identifier to a data center manager (DCM);
receive, from the DCM, firmware images corresponding to the hardware identifier; and
update firmware of the BMC and a basic input/output system (BIOS) based on the received firmware images.

12. The BMC of claim 11, wherein the hardware identifier is received from an I2C/I3C slave device on the HPM.

13. The BMC of claim 11, wherein the at least one processor is further configured to transmit the hardware identifier to the DCM using a Reduced Gigabit Media Independent Interface (RGMII).

14. The BMC of claim 11, wherein the at least one processor is further configured to trigger a system reset after updating the firmware of the BMC and the BIOS.

15. The BMC of claim 11, wherein the kickstarter firmware includes network capabilities, flash write capabilities for both BMC and BIOS flash devices, and read capabilities for I2C/I3C buses.

16. The BMC of claim 11, wherein the firmware images include a BMC firmware image specific to a BMC chip type and a BIOS image specific to a processor type of the HPM.

17. The BMC of claim 11, wherein the at least one processor is further configured to update the firmware by writing the received firmware images to a BIOS flash device and a BMC flash device within the BMC.

18. The BMC of claim 11, wherein the at least one processor is further configured to probe, via the kickstarter firmware, multiple I2C/I3C buses to locate the hardware identifier on the HPM.

19. The BMC of claim 11, wherein the DCM maintains a firmware repository containing multiple versions of BIOS and BMC firmware images, each associated with specific hardware identifiers.

20. A non-transitory computer-readable medium storing computer executable code for operation of a baseboard management controller (BMC), comprising code to:
read, by a kickstarter firmware of the BMC, a hardware identifier from a host processor module (HPM);
transmit, by the kickstarter firmware, the hardware identifier to a data center manager (DCM);
receive, from the DCM, firmware images corresponding to the hardware identifier; and
update firmware of the BMC and a basic input/output system (BIOS) based on the received firmware images.
